(19) United States
(12) Patent Application Publication
(10) Pub. No.: US 2014/0334600 A1
(43) Pub. Date: Nov. 13, 2014

(54) X-RAY DETECTOR, X-RAY IMAGING APPARATUS HAVING THE SAME AND METHOD OF CONTROLLING THE X-RAY IMAGING APPARATUS

(71) Applicant: SAMSUNG ELECTRONICS CO., LTD., Suwon-si (KR)

(72) Inventors: Kang Ho LEE, Hwaseong-si (KR); Young Hun SUNG, Hwaseong-si (KR)

(73) Assignee: SAMSUNG ELECTRONICS CO., LTD., Suwon-si (KR)

(21) Appl. No.: 14/271,842

(22) Filed: May 7, 2014

(30) Foreign Application Priority Data
May 7, 2013 (KR) 10-2013-0051160

(51) Int. Cl. G01T 1/172; G01N 23/04

(52) U.S. Cl. CPC G01T 1/172; G01N 23/04
USPC 378/62; 250/336.1; 378/98

(57) ABSTRACT

An X-ray detector includes a light receiver configured to generate charges of a quantity corresponding to energy of a photon, a comparison device including a plurality of comparators, each of the comparators being configured to compare a voltage signal corresponding to the quantity of the generated charges with a respective threshold voltage and output a result of the comparison as a pulse signal, a counter device including a plurality of counters, each of the counters being configured to count a pulse of a certain state, and a synchronous control circuit configured to receive as input the pulse signals output from each of the comparators and to output the pulse of the certain state to one of the counters corresponding to a highest threshold voltage of the threshold voltages which is less than a peak value of the voltage signal.

### CROSS-REFERENCE TO RELATED APPLICATION

This application claims priority to Korean Patent Application No. 2013-0051160 filed on May 7, 2013, in the Korean Intellectual Property Office, the disclosure of which is incorporated herein by reference in its entirety.

### BACKGROUND

1. Field

Exemplary embodiments of the present disclosure relate to an X-ray detector to count the number of photons according to energy bands, an X-ray imaging device including the X-ray detector and a method of controlling the X-ray imaging device.

2. Description of the Related Art

An X-ray imaging device observes an inner structure of an object by emitting X-rays to the object and analyzing X-rays transmitted through the object. An inner structure of the object is imaged by detecting an intensity or value of X-rays, because transmittance of X-rays changes depending upon substances constituting the object.

In recent years, an imaging method using multiple energy X-rays has been developed in order to increase contrast between substances constituting an object. X-ray images of different energy bands are required in order to obtain a multiple energy image. Methods for obtaining such an X-ray image include a method of separately emitting respective X-rays of different energy bands from an X-ray source, and a method of emitting X-rays of different energy bands from the X-ray source together once, and then detecting the X-rays by an X-ray detector and separating the X-rays according to the energy bands.

The latter method has an advantage of decreasing the exposure of the object (e.g., human body) to the X-rays, and further decreasing the noise of X-ray images. Research and development for improving a photon counting detector (PCD) used in the latter method are required.

### SUMMARY

Therefore, it is an aspect of the exemplary embodiments to provide an X-ray detector which separately counts the number of incident photons according to a plurality of energy bands and increases a count of only a counter corresponding to a highest one of threshold voltages which is less than a peak value of a voltage signal generated from each of the photons, an X-ray imaging device including the X-ray detector and a method of controlling the X-ray imaging device.

Additional aspects of the exemplary embodiments will be set forth in part in the description which follows and, in part, will be obvious from the description, or may be learned by practice of the exemplary embodiments.

In accordance with an aspect of an exemplary embodiment, there is provided an X-ray detector including a light receiver configured to generate charges of a quantity corresponding to energy of a photon when the photon is incident on the light receiver, a comparison device including a plurality of comparators, each of the comparators being configured to compare a voltage signal corresponding to the quantity of the generated charges with a respective threshold voltage among a plurality of threshold voltages corresponding respectively to a plurality of different energy bands and output a result of the comparison as a pulse signal, a counter device including a plurality of counters provided respectively according to the threshold voltages, each of the counters being configured to count a pulse of a certain state, and a synchronous control circuit provided between the comparison device and the counter device, the synchronous control circuit being configured to receive as input the pulse signals output from the comparator and to output the pulse of the certain state to one of the counters corresponding to a highest threshold voltage of the threshold voltages which is less than a peak value of the voltage signal and to output a pulse of a state opposite to the certain state to the remaining counters.

Each of the comparators of the comparison device may be configured to output a pulse of a high state or a low state, based on a result of the comparison.

The certain state of the pulse counted by each counter of the counter device may be a high state or a low state.

Each of the comparators of the comparison device may be configured to output the pulse of the high state when the voltage signal is higher than the threshold voltage and output the pulse of the low state when the voltage signal is lower than the threshold voltage.

The synchronous control circuit may be configured to output the pulse of the high state to one of the counters corresponding to the highest threshold voltage of the threshold voltages of comparators outputting the pulse of the high state, and output the pulse of the low state to the counters corresponding to the remaining threshold voltages.

The synchronous control circuit may include a plurality of storages configured to store the pulse signals output from the comparators and a logic circuit configured to perform a logical operation on the pulse signals output from the storages and output the pulse of the certain state to one of the counters corresponding to the highest one of the threshold voltages of the comparators outputting a pulse indicating that the voltage signal is higher than the respective threshold voltage.

In accordance with another aspect of an exemplary embodiment, there is provided an X-ray imaging device including an X-ray source configured to emit X-rays of a plurality of predetermined energy bands to an object and an X-ray detector configured to detect X-rays transmitted through the object, wherein the X-ray detector includes a light receiver configured to generate charges of a quantity corresponding to energy of a photon when the photon is incident on the light receiver, a comparison device including a plurality of comparators, each of the comparators being configured to compare a voltage signal corresponding to the quantity of the generated charges with a respective threshold voltage among a plurality of threshold voltages corresponding respectively to a plurality of different energy bands and output a result of the comparison as a pulse signal, a counter device including a plurality of counters provided respectively according to the threshold voltages, each of the counters being configured to count a pulse of a certain state and a synchronous control circuit provided between the comparison device and the counter device, the synchronous control circuit being configured to receive as input the pulse signals output from the comparator and to output the pulse of the certain state to one of the counters corresponding to a highest threshold voltage of the threshold voltages which is less than a peak value of the voltage signal and to output a pulse of a state opposite to the certain state to the remaining counters.

In accordance with another aspect of an exemplary embodiment, there is provided a method of controlling an X-ray imaging device configured to count a photon incident upon an X-ray detector, the method including emitting X-rays of a plurality of predetermined energy bands to an object, inputting a voltage signal generated based on a photon of one of the X-rays transmitted through the object to a plurality of comparators having respective threshold voltages corresponding respectively to the energy bands, comparing, by a comparator, the voltage signal with the threshold voltages and outputting a result of the comparing as a pulse signal, outputting a pulse of a certain state to a counter corresponding to a highest threshold voltage of the threshold voltages which is less than a peak value of the voltage signal, and outputting a pulse having a state opposite to the certain state to other counters corresponding to the remaining threshold voltages, based upon the output pulse signal and counting the pulse of the certain state by the counter corresponding to the highest threshold voltage.

### BRIEF DESCRIPTION OF THE DRAWINGS

These and/or other aspects of the exemplary embodiments will become apparent and more readily appreciated from the following description of the exemplary embodiments, taken in conjunction with the accompanying drawings of which:

FIG. 1 is a block diagram illustrating a controlled configuration of an X-ray imaging device according to an exemplary embodiment;

FIG. 2A illustrates an outer appearance of a general X-ray imaging device used as the X-ray imaging device according to an exemplary embodiment;

FIG. 2B illustrates an outer appearance of a technique of using the X-ray imaging device to perform breast imaging according to an exemplary embodiment;

FIG. 3A is a graph showing attenuation coefficients of bones, muscles and fat;

FIG. 3B is a graph showing attenuation coefficients of soft mammary tissues;

FIG. 4 is a schematic view illustrating a configuration of an X-ray tube;

FIG. 5 is a schematic view illustrating an example of a configuration of an X-ray detector;

FIG. 6A is a graph schematically illustrating energy bands corresponding to a plurality of single energy images to be acquired;

FIG. 6B is a graph showing energy bands of X-rays emitted from an X-ray source;

FIG. 7 is a schematic view illustrating a circuit configuration of a single pixel of an X-ray detector using a related art photon counting method;

FIG. 8 shows signals output according to a voltage pulse train input to the related art photon counting detector;

FIG. 9 is a block diagram illustrating an X-ray detector included in the X-ray imaging device according to an exemplary embodiment;

FIG. 10 is a schematic view illustrating a structure of a single pixel according to an exemplary embodiment of the X-ray detector;

FIG. 11A is a truth table showing inputs and outputs of a synchronous control circuit;

FIG. 11B is a schematic view illustrating outputs of the synchronous control circuit and count increments of counters according to inputs of the voltage pulse train;

FIG. 12 illustrates an example of a circuit structure of the synchronous control circuit;

FIG. 13 is a timing chart illustrating outputs from a register and a decoder of the synchronous control circuit when a voltage pulse is input;

FIG. 14 is a flowchart illustrating an example of an operation of the synchronous control circuit over the course of time when a voltage pulse is input by a single photon according to an exemplary embodiment; and

FIG. 15 is a flowchart illustrating a method of controlling the X-ray imaging device according to an exemplary embodiment.

### DETAILED DESCRIPTION

Hereinafter, an X-ray detector, an X-ray imaging device including the X-ray detector and a method of controlling the X-ray imaging device according to an exemplary embodiment will be described with reference to the accompanying drawings.

Structures and imaging methods of X-ray imaging devices may be changed according to imaging sites, types of X-ray images or imaging purposes. Specifically, the X-ray imaging device according to the exemplary embodiments may be implemented in many different ways, and may include a general X-ray imaging device for imaging a subject's chest, arms, legs and the like, an X-ray imaging device employing mammography as a breast imaging method, an X-ray imaging device employing fluoroscopy to form an image of an object on a fluorescent screen, an X-ray imaging device employing angiography, an X-ray imaging device employing cardiography, and the like. The X-ray imaging device according to the exemplary embodiments may be implemented as one of the X-ray imaging devices described above or may be implemented as a combination of two or more of the X-ray imaging devices described above.

In addition, the X-ray imaging device according to the exemplary embodiments may be used to form a phase contrast X-ray image as well. The phase contrast X-ray image is an image generated based upon phase changes due to refraction and interference of X-rays passing through substances constituting an object. The phase contrast X-ray image may be produced using X-ray images acquired from a plurality of different energy bands.

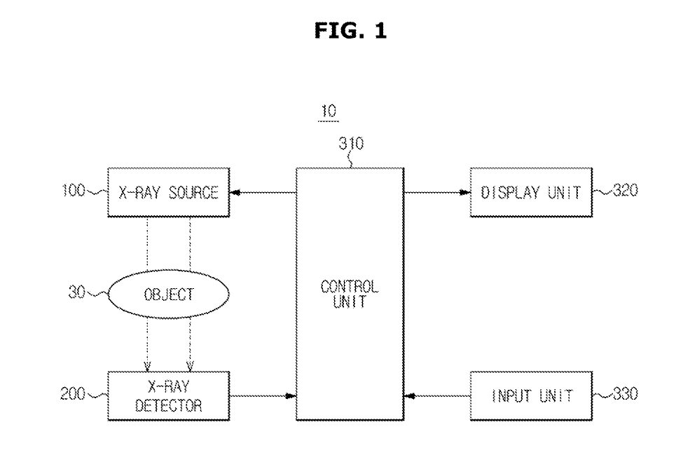

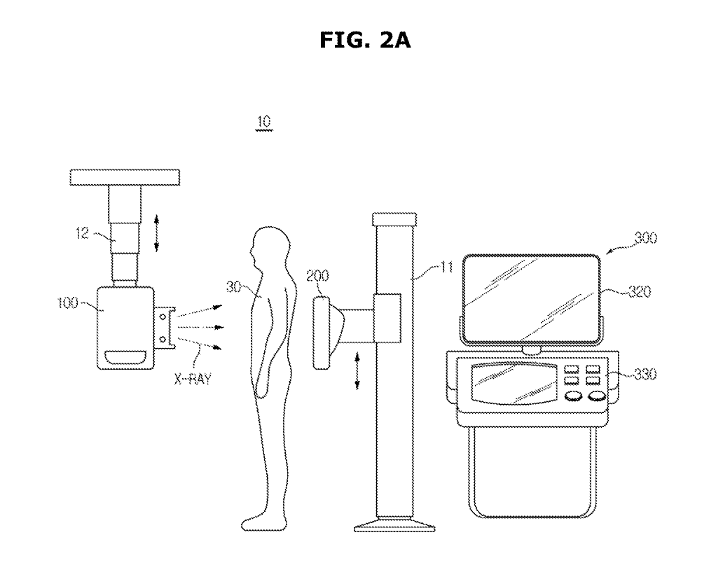

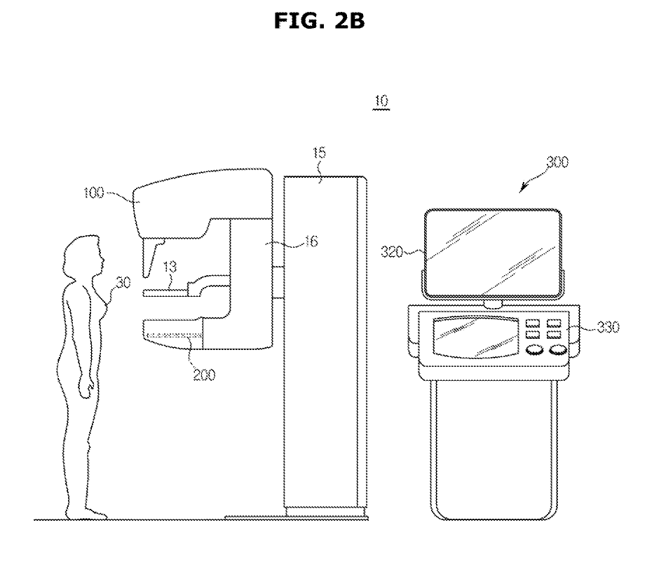

FIG. 1 is a block diagram illustrating a controlled configuration of an X-ray imaging device according to an exemplary embodiment, FIG. 2A illustrates an outer appearance of a general X-ray imaging device used as the X-ray imaging device according to an exemplary embodiment, and FIG. 2B illustrates an outer appearance of a technique using the X-ray imaging device to perform breast imaging according to an exemplary embodiment.

Referring to FIG. 1, the X-ray imaging device 10 according to an exemplary embodiment includes an X-ray source 100 to generate X-rays and emit the same to an object 30, an X-ray detector 200 to detect X-rays transmitted through the object 30 and convert the X-rays into X-ray data, a control unit 310 (e.g., controller) to control X-rays generated by the X-ray source 100 and to produce an X-ray image using the X-ray data output from the X-ray detector 200, a display unit 320 to display the produced X-ray image, and an input unit 330 to input user commands associated with operations of the X-ray imaging device 10.

Referring to FIGS. 2A and 2B, the object 30 is disposed between the X-ray source 100 and the X-ray detector 200 and, when the X-ray source 100 emits X-rays to the object 30, the X-ray detector 200 detects X-rays transmitted through the object 30.

The X-ray imaging device 10 includes a host device 300 to provide a user interface. According to an exemplary embodiment, the host device 300 may include a display unit 320 to display an X-ray image and an input unit 330 to input user commands associated with operations of the X-ray imaging device 10.

According to an exemplary embodiment, the term object may refer to a test site of a subject which is a target of diagnosis using the X-ray imaging device 10, that is, an X-ray imaging site. The subject may be a living thing such as a human or animal, but the exemplary embodiments are not limited thereto. Any type of item (e.g., items passing through security, etc.) may be used as the subject so long as an inner structure thereof may be imaged by the X-ray imaging device 10.

In addition, the user may perform diagnosis of the subject using the X-ray imaging device 10 and may be a member of medical staff, such as a doctor, a radiological technologist, a nurse or the like, but the exemplary embodiments are not limited thereto. Many different types of user may use the X-ray imaging device 10.

In the case in which the X-ray imaging device 10 is a general X-ray imaging device, as shown in FIG. 2A, the X-ray source 100 and the X-ray detector 200 are moved to positions corresponding to the object 30. The X-ray imaging device 10 may have a configuration in which the X-ray source 100 is mounted on a holder 12 connected to a ceiling and has a controllable length and the X-ray detector 200 is mounted on a support stand 11 such that the X-ray detector 200 is movable upwards and downwards in order to image the object 30 of the standing or sitting subject.

In addition, when the subject is laid on a table, the X-ray detector 200 may be mounted such that the X-ray detector 200 is movable inside the table in a length direction of the table and the X-ray source 100 may be mounted such that the X-ray source 100 is movable along the ceiling in the length direction of the table.

In the case in which the X-ray imaging device 10 is an X-ray imaging device to image the breasts, as shown in FIG. 2B, a breast as the object 30 is disposed in an upper part of the X-ray detector 200 and X-rays are emitted to the object 30 from an upper part of the object 30. The breast 30 may be compressed using a compression paddle 13 in order to acquire a clear X-ray image of the breast and the compression paddle 13 may be mounted in a frame 16 so as to be movable upwards and downwards.

According to an exemplary embodiment, the X-ray imaging device 10 is an apparatus which images an inside of the object 30 based upon differences in X-ray attenuation among substances constituting the object 30. A value numerically indicating X-ray attenuation properties of substances is an attenuation coefficient and the attenuation coefficient is represented by the following Equation 1:

I=I₀*exp(−μ(E)T) [Equation 1]

wherein I₀ is an intensity of X-rays passing through an object, I is an intensity of X-rays transmitted through the object, μ(E) is an attenuation coefficient of a substance with respect to X-rays having an energy E, and T is a thickness of a substance through which X-rays pass. In accordance with Equation 1, as the attenuation coefficient increases, the intensity of transmitted X-rays decreases.

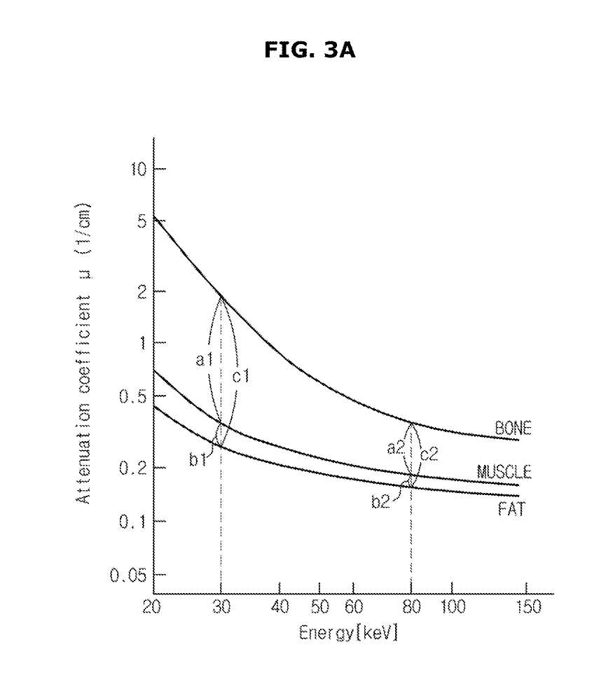

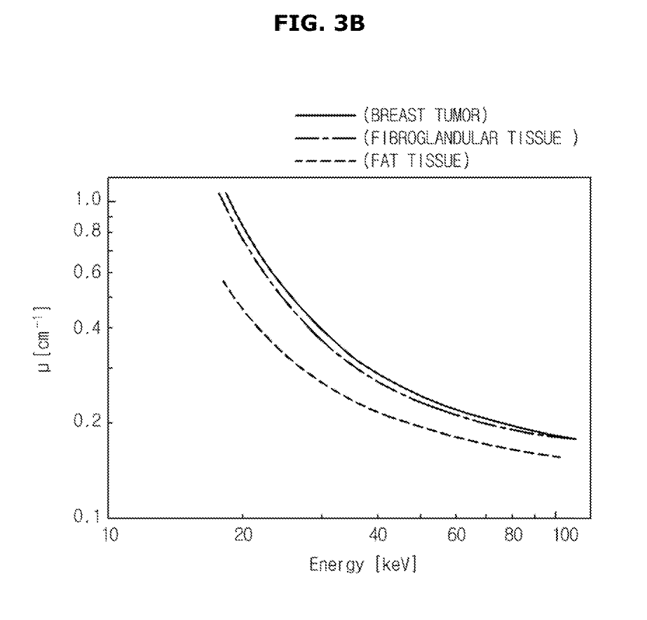

FIG. 3A is a graph showing attenuation coefficients of bones, muscles and fat, and FIG. 3B is a graph showing attenuation coefficients of soft tissues constituting the breasts.

Referring to FIG. 3A, a curve showing an attenuation coefficient of bones is disposed above a curve showing an attenuation coefficient of soft tissues (muscles and fat), which indicates that X-ray transmissivity of soft tissues is higher than X-ray transmissivity of bones. In addition, comparing a curve showing an attenuation coefficient of muscles with a curve showing an attenuation coefficient of fat, X-ray transmissivity of muscles is lower than X-ray transmissivity of fat.

In addition, the difference between attenuation coefficients may be changed according to intensity of energy. For example, a difference (a1) between the attenuation coefficient of bones and the attenuation coefficient of muscles when an energy intensity of X-rays is 30 keV is greater than a difference (a2) between the attenuation coefficient of bones and the attenuation coefficient of muscles when an energy intensity of X-rays is 80 keV. That is, as the energy of X-rays decreases, a difference in the attenuation coefficient between bones and muscles increases.

Furthermore, the differences (c1 and c2) in the attenuation coefficient between bones and fat also exhibit similar behavior. Moreover, although the difference is not great, the differences (b1 and b2) in the attenuation coefficient between muscles and fat are also greater in lower energy bands.

Referring to FIG. 3B, regarding soft mammary tissues, the difference in the attenuation coefficient between a breast tumor, fibroglandular tissue and fat tissue changes according to the energy intensity of X-rays and as the energy band becomes lower, the attenuation coefficient difference increases.

The X-ray imaging device 10 may employ the fact that the difference in the attenuation coefficient between substances changes according to the energy of X-rays in order to obtain X-ray images having improved contrast between substances constituting the object.

Specifically, X-ray images corresponding to different energy bands are acquired and an X-ray image in which substances constituting the object are separated or a certain substance is more clearly seen as compared to other substances is produced using the acquired X-ray images. According to an exemplary embodiment, such an X-ray image is referred to as a “multiple energy image” and a general X-ray image corresponding to each energy band is referred to as a “single energy image”.

In order to produce a multiple energy image, first, a single energy image corresponding to each of the different energy bands should be acquired. A method of acquiring the single energy image corresponding to each energy band includes a method of separately emitting respective X-rays of a plurality of energy bands from an X-ray source and a method of emitting X-rays of all of a plurality of energy bands from the X-ray source once, detecting X-rays using an X-ray detector and separating the X-rays according to the energy bands.

The X-ray imaging device 10 employs the latter method in order to minimize an X-ray exposure dose of the object 30 and to minimize loading of the X-ray source 100, as well as to acquire multiple energy images with excellent image quality.

Hereinafter, operations of respective components of the X-ray imaging device 10 will be described in detail.

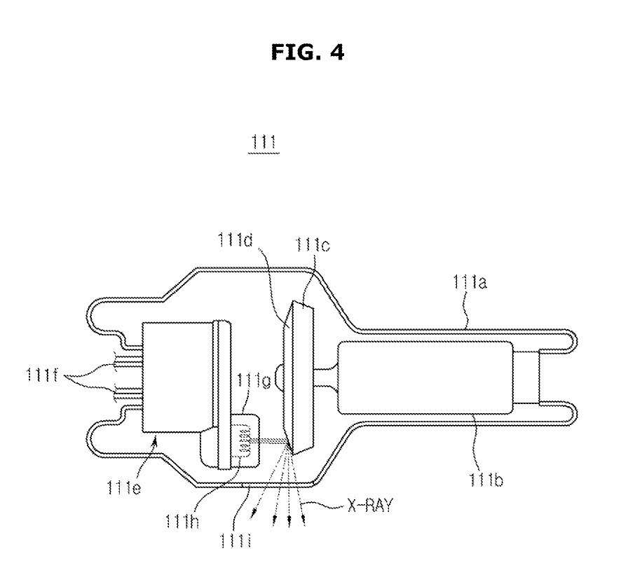

FIG. 4 is a schematic view illustrating a configuration of an X-ray tube.

The X-ray source 110 includes an X-ray tube 111 to generate X-rays. Referring to FIG. 4, the X-ray tube 111 is implemented as a two-electrode vacuum tube including an anode 111c, a cathode 111e, and a tube body 111a, which may be a glass tube made of hard silicate glass or the like.

The cathode 111e includes a filament 111h and a focusing electrode 111g to focus electrons, and the focusing electrode 111g may also be referred to as a “focusing cup”. A glass tube 111a is vacuumized to a high level of about 10 mmHg and the filament 111h of the cathode is heated to a high temperature to generate thermoelectrons. An example of the filament 111h is a tungsten filament. The filament 111h may be heated by applying current to an electric wire 111f connected to the filament. It is understood that the exemplary embodiments are not limited to use of the filament 111h as the cathode 111e and carbon nanotubes, which may be operated at a fast pulse, may alternatively be used as the cathode.

The anode 111c is generally made of copper, a target material 111d is applied or disposed opposite to the cathode 111e, and the target material 111d may be a high-resistance material such as Cr, Fe, Co, Ni, W or Mo. As a melting point of the target material increases, a focal spot size decreases.

When high voltage is applied between the cathode 111e and the anode 111c, the thermoelectrons accelerate and collide with the target material 111g of the anode to generate X-rays. The generated X-rays are emitted to the outside through a window 111i and a material constituting the window 111i may be a beryllium (Be) thin film. A filter is disposed on a front or rear surface of the window 111i to filter a specific energy band of X-rays.

The target material 111d is rotated by a rotor 111b. When the target material 111d is rotated, heat accumulation is increased by 10-fold or more and focal spot size decreases, as compared to when the target is fixed.

The voltage applied between the cathode 111e and the anode 111c of the X-ray tube 111 is referred to as a “tube voltage” and a level of the voltage is represented as kVp. As tube voltage increases, a velocity of thermoelectrons increases and as a result, the energy of X-rays (energy of photons) generated by a collision of thermoelectrons with the target material increases. A current flowing in the X-ray tube 111 is referred to as a “tube current” and is represented as mA (mean amperage). As tube current increases, the number of thermoelectrons emitted from the filament increases and as a result, a dose of the X-rays (energy of photons) increases.

Accordingly, an the energy of X-rays is controlled by a tube voltage, and an intensity or dose of X-rays is controlled by tube current and X-ray exposure time. Energy and intensity of emitted X-rays may be controlled according to the type or characteristics of the object 30.

The X-ray emitted from the X-ray source 100 may have a predetermined energy band and the energy band may be defined by an upper limit and a lower limit. According to an exemplary embodiment, the energy bands are considered to be different when at least one of the upper and lower limits of the energy bands is different and the X-ray source 100 may emit X-rays having a plurality of predetermined different energy bands. The different energy bands are energy bands which are separated in order to produce multiple energy images of the object and are set according to type or characteristics of the object.

The upper limit of the energy band, that is, the maximum energy of emitted X-rays, is controlled by tube voltage, and a lower limit of an energy band, that is, a minimum energy of emitted X-rays, may be controlled by a filter provided in the X-ray source 100. When low energy bands of X-rays are filtered through the filter, an average energy of the emitted X-rays is increased.

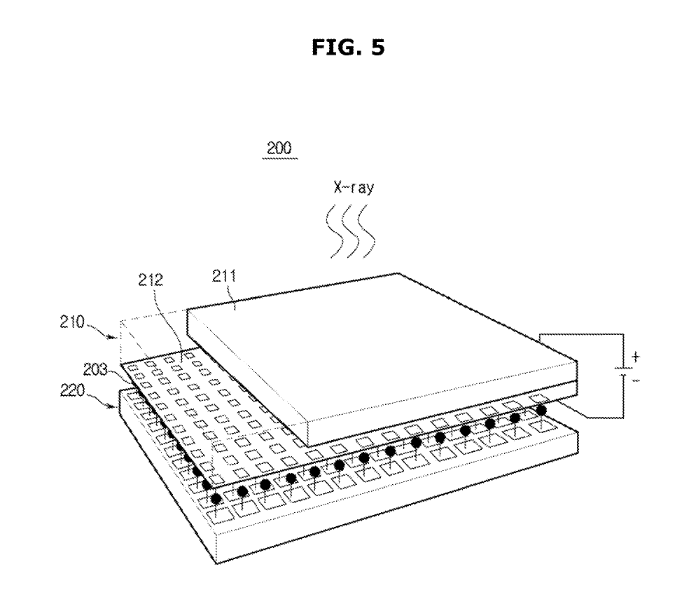

FIG. 5 is a schematic view illustrating an example of a configuration of the X-ray detector.

According to an exemplary embodiment, the X-ray detector 121 includes a light-receiving element 210 to detect an X-ray and convert the same into an electrical signal and a readout circuit 220 to read the electrical signal.

A single crystal semiconductor material may be used as a material constituting the light-receiving element 210 in order to secure high resolution, rapid response time and a high dynamic area at low energy and at a low dose, and examples of the single crystal semiconductor material include Ge, CdTe, CdZnTe, GaAs and the like.

The light-receiving element 210 is formed as a PIN photodiode in which a p-type layer 212 including a p-type semiconductor aligned as a two-dimensional pixel array is bonded to a lower part of a high-resistance n-type semiconductor substrate 211 and the readout circuit 220 using a CMOS process is also formed as a two-dimensional pixel array and is bonded to the light-receiving element 210 on a pixel basis.

When photons of X-rays are incident upon the light-receiving element 210, electrons present in a valence band receive energy of the photons and are excited to a conduction band above the band gap energy difference. As a result, electron-hole pairs are generated in a depletion region.

When metal electrodes are formed on the p-type layer 212 and the n-type substrate 211 of the light-receiving element 210 and a reverse bias is applied thereto, among the electron-hole pairs generated in the depletion region, electrons are attracted to an n-type region and holes are attracted to a p-type region.

In addition, the holes attracted to the p-type region are input to the readout circuit 220, thus allowing an electrical signal generated from the photons to be read out. Electrons are input to the readout circuit 220 according to the structure of the light-receiving element 210 and applied voltage, thus producing an electrical signal.

The readout circuit 220 and the light-receiving element 210 may be bonded to each other in a flip-chip bonding manner and bonding is carried out by forming a bump 203 out of a material such as solder (PbSn) or indium (In), followed by reflowing and compressing the same while heating. The holes attracted to the p-type region may be input to the readout circuit 220 through the bump 203. A detailed description of a configuration of a pixel of the readout circuit 220 will be given below.

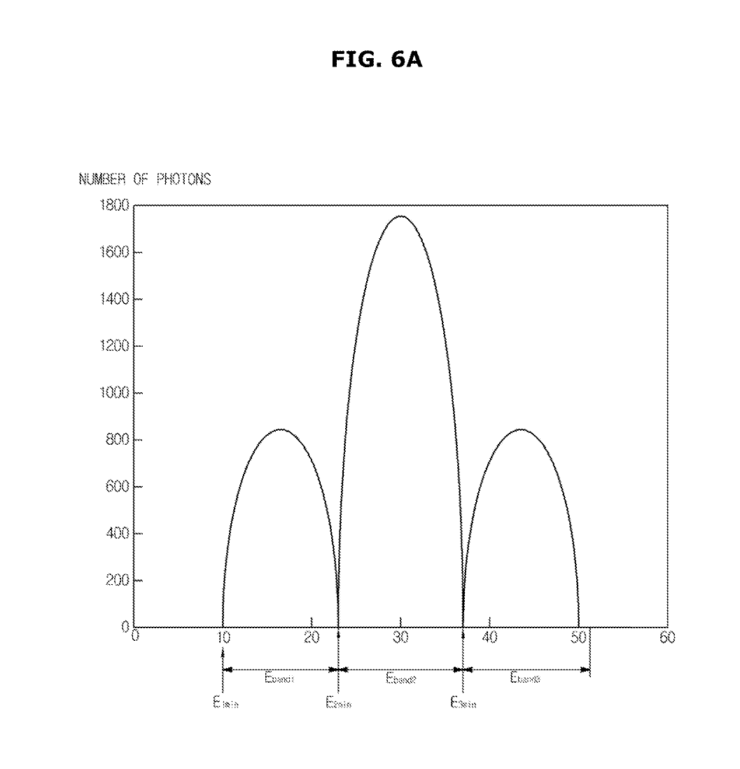

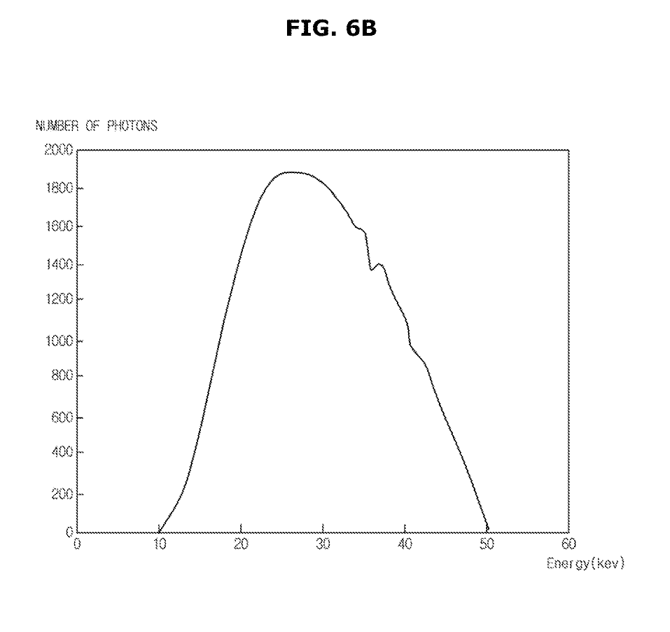

FIG. 6A is a graph schematically illustrating energy bands corresponding to a plurality of single energy images and FIG. 6B is a graph showing energy bands of X-rays emitted from the X-ray source.

For example, in the case in which the X-ray imaging device 10 targets a breast as the object 30, single energy images corresponding respectively to three different energy bands (E_{band1}, E_{band2} and E_{band3}) may be acquired in order to produce a multiple energy image, as shown in FIG. 6A.

For this purpose, the X-ray source 100 may emit an X-ray having all of the three different energy bands, as shown in FIG. 6B. That is, an upper limit and a lower limit of energy of the X-ray emitted from the X-ray source 100 may be 50 keV and 10 keV, respectively. For this purpose, an X-ray is generated at a tube voltage of the X-ray tube 111 of 50 kVp and a low energy band (about 0 to 10 keV) of the X-ray is filtered out.

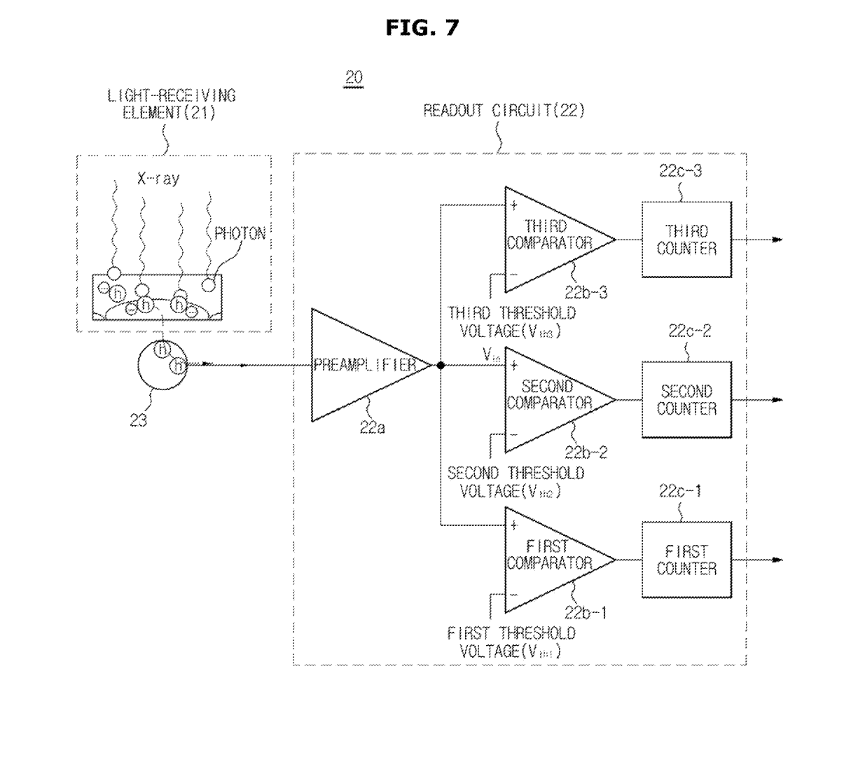

FIG. 7 is a schematic view illustrating a configuration of a circuit of a single pixel of an X-ray detector using a related art photon counting method.

The X-ray detector 20 using a photon counting method as shown in FIG. 7 is used to separate X-rays emitted from the X-ray source according to energy bands. For example, so as to separate the detected X-rays into three energy bands as shown in FIG. 6A, three comparison circuits are provided in the pixel region of the X-ray detector 20.

Specifically, when electrons or holes generated in the light-receiving element 21 by a single photon pass through a preamplifier 22a of the readout circuit 22 connected to the light-receiving element 21 by bonding via a bump 203 and are output as voltage signals, the voltage signals (V₁ₙ) are input to three comparators 22b-1, 22b-2 and 22b-3.

Threshold voltages corresponding to energy bands to be separated are input to respective comparators. Levels of generated voltage signals are changed according to the energy of incident photons. Accordingly, levels of voltages corresponding to lower limit energies of energy bands to be separated are calculated and are input as threshold voltages to the respective comparators.

A first threshold voltage Vₜₕ₁ corresponding to a lower limit energy E₁ₘᵢₙ of the first energy band E_{band1} is input to the first comparator 22b-1, a second threshold voltage Vₜₕ₂ corresponding to a lower limit energy E₂ min of the second energy band E_{band2} is input to the second comparator 22b-2, and a third threshold voltage Vₜₕ₃ corresponding to a lower limit energy E₃ min of the third energy band E_{band3} is input to the third comparator 22b-3.

The first comparator 22b-1 compares the first threshold voltage Vₜₕ₁ with the input voltage V₁ₙ. The first comparator 22b-1 outputs a pulse indicating a high state, that is, ‘1’, when the input voltage V₁ₙ is higher than the first threshold voltage Vₜₕ₁, and outputs a pulse indicating a low state, that is, ‘0’, when the input voltage V₁ₙ is lower than the first threshold voltage Vₜₕ₁.

The first counter 22c-1 receives as input a pulse signal output from the first comparator 22b-1 and the first counter 22c-1 counts the number of times, that is, the number of pulses, at which the first comparator 22b-1 outputs ‘1’. The value counted by the first counter 22c-1 is the number of photons generating voltages greater than the first threshold voltage Vₜₕ₁, that is, the number of photons having energy greater than the lower limit energy of the first energy band.

In the same manner, the second counter 22c-2 counts the number of photons generating a voltage greater than the second threshold voltage Vₜₕ₂, and the third counter 22c-3 counts the number of photons generating voltages greater than the third threshold voltage Vₜₕ₃.

Alternatively, the comparators 22b-1, 22b-2 and 22b-3 may be designed to output ‘0’ when an input voltage is greater than a threshold voltage and to output ‘1’ when the input voltage is less than the threshold voltage. In this case, the counter counts the number of times at which the comparator outputs ‘0’. According to the following exemplary embodiment, for convenience of description, the comparator outputs a pulse of a high state, that is, ‘1’, when the input voltage is greater than the threshold voltage and the counter counts the number of times at which the comparator outputs ‘1’.

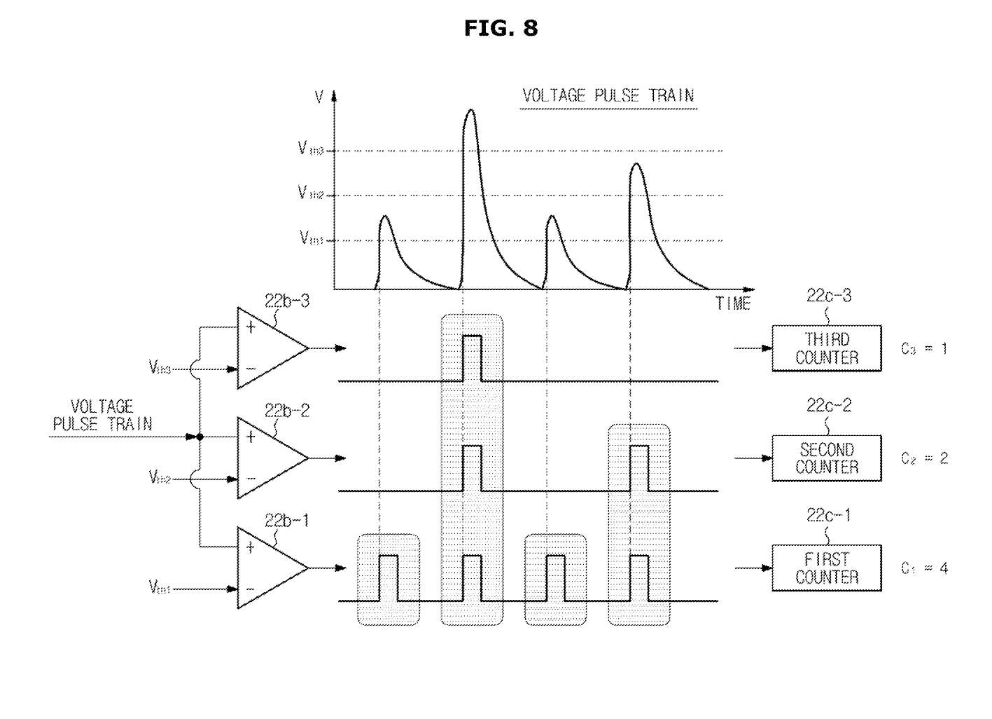

FIG. 8 shows signals which are output according to a voltage pulse train and then input to the related art photon counting detector.

Voltage signals input to the respective comparators are analog signals, but values thereof sharply vary within a short time and are converted into pulses. Output signals of respective comparators and counts of the respective counters when the voltage pulse train shown in FIG. 8 is input to the respective comparators 22b-1, 22b-2 and 22b-3 are described below. The count gradually increases from the first threshold voltage Vₜₕ₁ to the third threshold voltage Vₜₕ₃.

When the first voltage pulse (the left-most voltage pulse in FIG. 8) which is greater than the first threshold voltage Vₜₕ₁ and is less than the second threshold voltage Vₜₕ₂ is input to the first comparator 22b-1, the second comparator 22b-2 and the third comparator 22b-3, the third comparator 22b-3 and the second comparator 22b-2 output ‘0’ and the first comparator 22b-1 outputs ‘1’.

When a voltage pulse which is greater than the third threshold voltage Vₜₕ₃ is input to the first comparator 22b-1, the second comparator 2b-2 and the third comparator 22b-3, all of the first comparator 22b-1 to the third comparator 22b-3 output ‘1’, and when a third voltage pulse which greater than the first threshold voltage Vₜₕ₁ and less than the second threshold voltage Vₜₕ₂ is input to the first comparator, the second comparator 2b-2 and the third comparator 22b-3, the third comparator 22b-3 and the second comparator 22b-2 output ‘0’ and the first comparator 22b-1 outputs ‘1’.

Finally, when a fourth voltage pulse which is greater than the second threshold voltage Vₜₕ₂ and less than the third threshold voltage Vₜₕ₃ is input to the first comparator 22b-1, the second comparator 2b-2 and the third comparator 22b-3, the third comparator 22b-3 outputs ‘0’, and the first comparator 22b-1 and the second comparator 2b-2 output ‘1’.

In addition, the respective counters independently count the number of times at which the comparators output ‘1’. That is, regardless of pulse signals input to other counters, each counter performs a counting operation only upon a pulse signal input thereto.

Accordingly, in the example shown in FIG. 8, the first counter 22c-1 outputs 4 as a count C₁, the second counter 22c-2 outputs 2 as a count C₂, and the third counter 22c-3 outputs 1 as a count C₃. That is, the first counter 22c-1 counts all photons generating voltages greater than the first threshold voltage Vₜₕ₁, and the second counter 22c-2 counts all photons generating voltages greater than the second threshold voltage Vₜₕ₂. The third counter 22c-3 also does the same.

For this reason, the counters repeat many digital operations, causing coupling noise in analog blocks and resulting in signal distortion and deterioration in sensitivity. In addition, a dynamic current is produced according to charge and discharge of electric charges, voltage may be lost due to inner inductance, and power efficiency may be deteriorated due to a switching operation.

Accordingly, the X-ray imaging device 10 according to an exemplary embodiment shares results of the comparator corresponding to each energy band and increases a count of only the counter connected to the comparator having the highest threshold voltage among the comparators which output ‘1’, thereby minimizing a digital operation of the X-ray detector. This operation of the X-ray imaging device 10 may be explained by using various expressions. In the following description of an exemplary embodiment, the photon counting operation of the X-ray imaging device 10 may be explained by using various expressions. It is noted that different expressions may refer to the same operation.

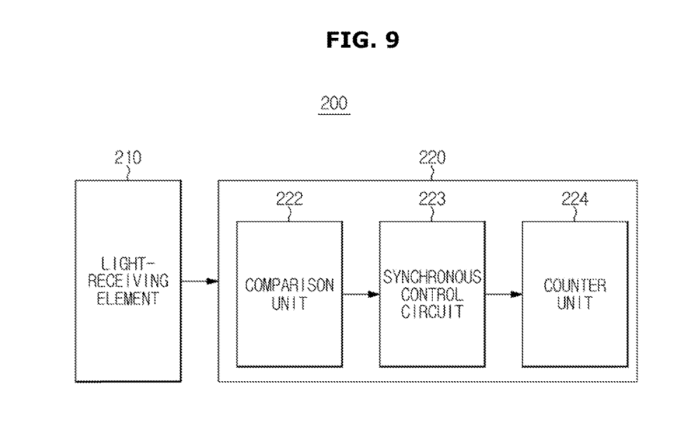

FIG. 9 is a block diagram illustrating an X-ray detector included in the X-ray imaging device according to an exemplary embodiment.

As discussed with reference to FIG. 5 above, the X-ray detector 200 includes a light-receiving element 210 (e.g., light receiver) to detect X-rays and a readout circuit 220 to read an electrical signal from the detected X-rays and acquire X-ray data. The light-receiving element 210 generates electric charges (electrons or holes) of a quantity corresponding to energy of photons of the X-rays and the readout circuit 220 reads out an electrical signal derived from the generated charges.

Referring to FIG. 9, the readout circuit 220 includes a comparison unit (e.g., comparison device) 222 to compare a value of a voltage signal generated by the photons of X-rays detected from the light-receiving element 210 with a plurality of threshold voltages corresponding to a plurality of energy bands and to output result of the comparison as a pulse represented by a ‘1’ (high) or ‘0’ (low) state, a synchronous control circuit 223 to transfer a pulse signal having a highest threshold voltage to be compared, that is, a pulse signal of a greatest energy band among pulse signals indicating ‘1’ output from the comparison unit 222 to the counter unit 224 (e.g., counter device) and transfer all of the remaining pulse signals indicating ‘0’ to the counter unit 224, and the counter unit 224 to count the number of pulses transferred from the synchronous control circuit 223 according to respective energy bands.

That is, the counter unit 224 increases a count of only one of the counters corresponding to a highest one of threshold voltages which is less than a peak value of a voltage signal generated by a single photon and decreases a digital operation as compared to a related art photon counting detector which increases counts of all counters corresponding to the threshold voltages which are less than the peak value of the voltage signal.

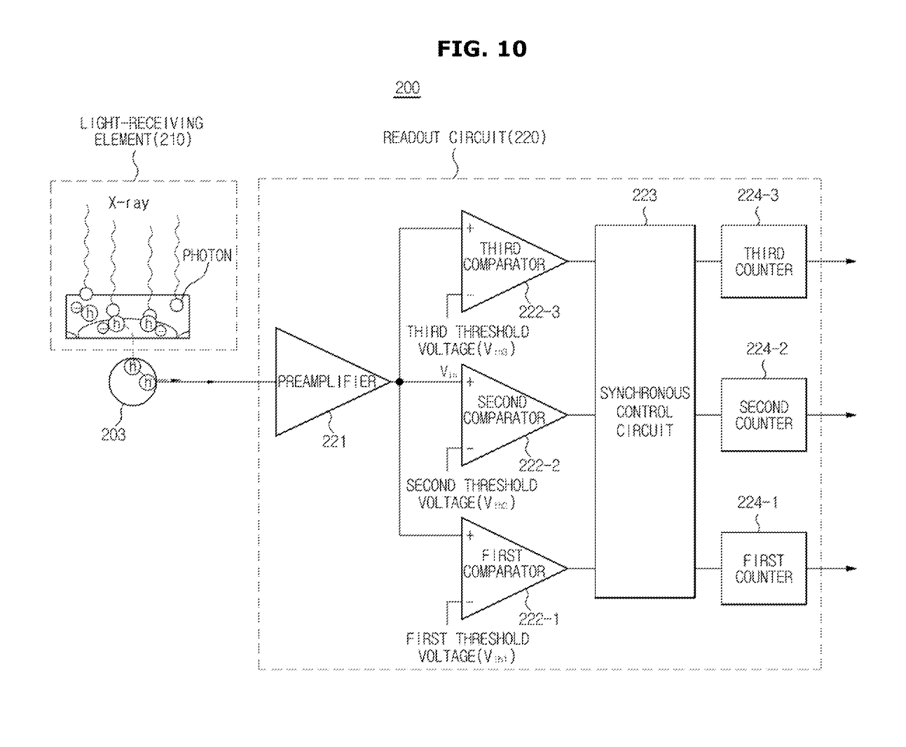

FIG. 10 is a schematic view illustrating a structure of a single pixel according to an example of the X-ray detector. In the example of FIG. 10, incident photons are separated according to three energy bands.

Referring to FIG. 10, as described above, a single photon incident upon the light-receiving element 210 generates electron-hole pairs and electrons or holes (in the present example, holes) are input to the readout circuit 220 through the bump 203 according to the structure of the light-receiving element 210 and applied voltage. The input hole passes through a preamplifier 221 and is then output as an amplified voltage signal and the voltage signal is commonly input to comparators provided respectively according to energy bands.

The comparison unit 222 includes a first comparison unit 222-1, a second comparison unit 222-2 and a third comparison unit 222-3 corresponding respectively to three energy bands to be separated. The first comparison unit 222-1 receives as input a first threshold voltage Vₜₕ₁ corresponding to a low one of the three energy bands, the second comparison unit 222-2 receives as input a second threshold voltage Vₜₕ₂ corresponding to a medium one of the three energy bands, and the third comparison unit 222-3 receives as input a third threshold voltage Vₜₕ₃ corresponding to a high one of the three energy bands.

The counter unit 224 also includes a first counter 224-1, a second counter 224-2 and a third counter 224-3 corresponding respectively to the three energy bands to be separated or the three threshold voltages.

The synchronous control circuit 223 is provided between the comparison unit 222 and the counter unit 224. When a pulse signal output from the comparison unit 222 is input to the synchronous control circuit 223, the synchronous control circuit 223 sets outputs corresponding to inputs in a ‘1’ state and having the highest threshold voltage providing a basis thereof to a ‘1’ state and sets outputs corresponding to the remaining inputs to a ‘0’ state.

That is, the synchronous control circuit 223 sets only an output line connected to the counter corresponding to a highest one of threshold voltages which is less than a peak value of the voltage signal V₁ₙ, to ‘1’.

In other words, the synchronous control circuit 223 outputs ‘1’ to the counter corresponding to the comparator having the highest threshold voltage among the comparators outputting a pulse of a ‘1’ state.

That is, unlike the related art photon counting detector 20 that independently counts the number of times at which the comparator outputs ‘1’, the X-ray detector 200 according to an exemplary embodiment synchronizes pulse signals output from respective comparators and produces outputs to the counter.

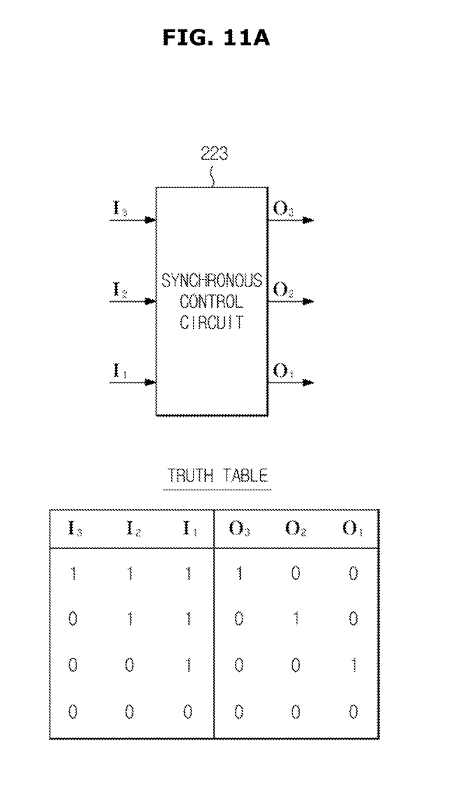

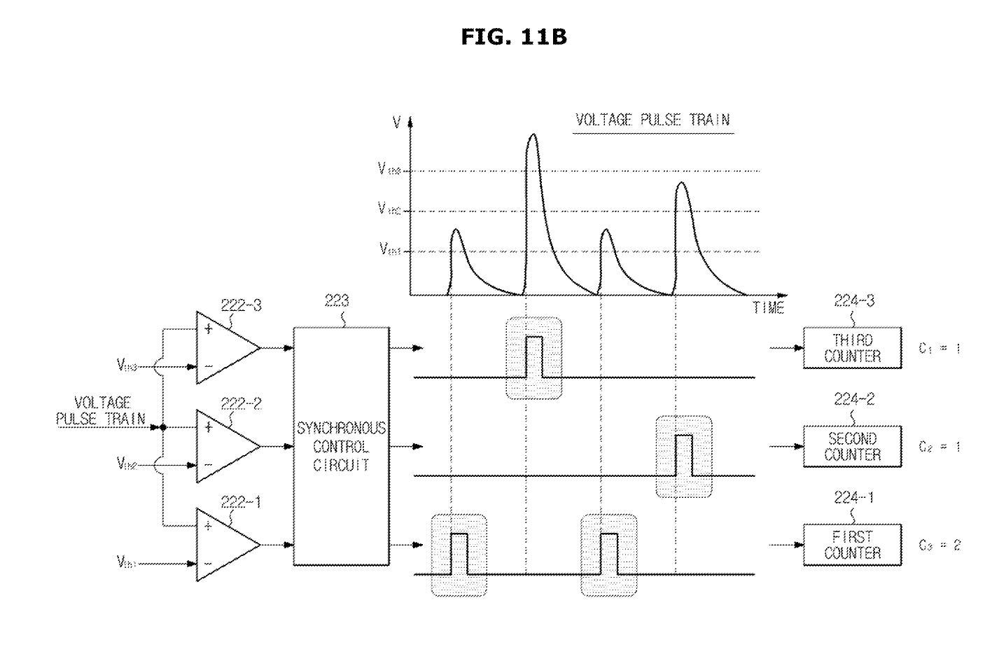

FIG. 11A is a truth table showing inputs and outputs of the synchronous control circuit 223, and FIG. 11B is a schematic view illustrating outputs of the synchronous control circuit 223 and a count increment according to inputs of a voltage pulse train.

As described above, pulse signals output from the respective comparators 222-1, 222-2 and 222-3 are inputs I₁, I₂ and I₃ of the synchronous control circuit 223. Referring to FIG. 11A, the synchronous control circuit 223 produces outputs O₁, O₂ and O₃ corresponding respectively to the inputs through various logical operations.

According to an exemplary embodiment, the corresponding relation between the inputs and the outputs is determined depending on energy bands. For example, when an output of the first comparison unit 222-1 corresponding to the first energy band, that is, an output of the first comparison unit 222-1 having the first threshold voltage Vₜₕ₁ becomes an input of the synchronous control circuit 223, the output corresponding to the input becomes an output which is input to the counter 224-1 corresponding to the first energy band.

Referring to FIG. 11A, input sets of the synchronous control circuit 223 connected to the three comparators 222-1, 222-2 and 222-3 are four in number. Specifically, when the input voltage V₁ₙ is greater than the third threshold voltage Vₜₕ₃, all three comparators output ‘1’ and all three inputs I₁, I₂ and I₃ of the synchronous control circuit 223 are ‘1’. It is understood that the input sets may be more or less than four in number.

When the input voltage V₁ₙ is less than the third threshold voltage Vₜₕ₃ and is greater than the second threshold voltage Vₜₕ₂, the first comparison unit 222-1 and the second comparison unit 222-2 output ‘1’ and the third comparison unit 222-2 outputs ‘0’. Accordingly, inputs I₁ and I₂ of the synchronous control circuit 223 are ‘1’ and the input I₃ thereof is ‘0’.

When the input voltage V₁ₙ is less than the second threshold voltage Vₜₕ₂ and is greater than the first threshold voltage Vₜₕ₁, the first comparison unit 222-1 outputs ‘1’, and the second comparison unit 222-2 and the third comparison unit 222-3 output ‘0’. Accordingly, the input I₁ of the synchronous control circuit 223 is ‘1’ and the inputs I₂ and I₃ thereof are ‘0’.

When the input voltage V₁ₙ is less than the first threshold voltage Vₜₕ₁, each of the first comparison unit 222-1, the second comparison unit 222-2 and the third comparison unit 222-3 output ‘0’, and each of the inputs I₁, I₂ and I₃ of the synchronous control circuit 223 are ‘1’.

The synchronous control circuit 223 generates only the output corresponding to the input corresponding to the greatest energy band among inputs having a ‘1’ state, to be ‘1’, and generates all remaining outputs to be ‘0’.

Accordingly, as described in the truth table of FIG. 11A, when inputs of the synchronous control circuit 223 are I₃=1, I₂=1 and I₁=1, outputs thereof are O₃=1, O₂=0, and O₃=0, and when inputs are I₃=0, I₂=1 and I₁=1, outputs are O₃=0, O₂=1 and O₁=0. In addition, when the inputs are I₃=0, I₂=0 and I₁=1, outputs are O₃=0, O₂=0 and O₁=1, and when inputs are I₃=0, I₂=0 and I₁=0, outputs are O₃=0, O₂=0 and O₁=0.

Inputs and outputs of the synchronous control circuit 223, and inputs and outputs of the counters 224-1, 224-2 and 224-3, are exemplarily described based upon a case in which the voltage pulse train shown in FIG. 11B is input as an input voltage V₁ₙ to the comparators 222-1, 222-2 and 222-3.

When a voltage pulse as a first voltage pulse (the left-most voltage pulse in FIG. 11B) which is greater than the first threshold voltage and less than the second threshold voltage is input to the comparators 222-1, 222-2 and 222-3, inputs of the synchronous control circuit 223 are I₃=0, I₂=0 and I₁=1 and, as is apparent from the truth table of FIG. 11A above, inputs of the synchronous control circuit 223 are O₃=0, O₂=0 and O₁=1. According to an exemplary embodiment, the expression that the voltage pulse is greater or less than a certain threshold voltage refers to a peak value of the voltage pulse being greater or less than the certain threshold voltage. That is, a subject compared with the certain threshold voltage is a peak value of the voltage pulse.

When a second voltage pulse which is greater than a third threshold voltage is input to the comparators 222-1, 222-2 and 222-3, inputs of the synchronous control circuit 223 are I₃=1, I₂=1 and I₁=1, and outputs of the synchronous control circuit 223 are O₃=1, O₂=0 and O₁=0 as indicated by the truth table of FIG. 11A described above.

When a third voltage pulse which is greater than the first threshold voltage and less than the second threshold voltage is input to the comparators 222-1, 222-2 and 222-3, inputs of the synchronous control circuit 223 are I₃=0, I₂=0 and I₁=1, and outputs of the synchronous control circuit 223 are O₃=0, O₂=0 and O₁=1 as indicated by the truth table of FIG. 11A described above.

When a fourth voltage pulse which is greater than the second threshold voltage and less than the third threshold voltage is input to the comparators 222-1, 222-2 and 222-3, inputs of the synchronous control circuit 223 are I₃=0, I₂=1 and I₁=1, and outputs of the synchronous control circuit 223 are O₃=0, O₂=1 and O₁=0, as indicated by the truth table of FIG. 11A described above.

The outputs O₃, O₂, and O₁ of the synchronous control circuit 223 become inputs of the third counter 224-3, the second counter 224-2 and the first counter 224-1. Thus, according to the example shown in FIG. 11B, a count C3 of the third counter 224-3 is 1, a count C2 of the second counter 224-2 is 1, and a count C1 of the third counter 224-3 is 2.

Comparing a counting operation of the related art photon counting detector 20 with a counting operation of the X-ray detector 200 with reference to FIGS. 8 and 11B, when a voltage pulse greater than the third threshold voltage is input, in the related art photon counting detector 20, each of the first counter 22b-1 to third counter 22b-3 receive an input of ‘1’ and all counts C₁, C₂ and C₃ are increased, while in the X-ray detector 200, only the third counter 224-3 receives an input of ‘1’ and only the count C₃ is increased.

In addition, when a voltage pulse greater than the second threshold voltage Vₜₕ₂ and less than the third threshold voltage Vₜₕ₃ is input, in the conventional photon counting detector 20, both the first counter 22b-1 and the second counter 22b-2 receive an input of ‘1’ and counts C₁ and C₂ are increased, while in the X-ray detector 200, only the second counter 224-2 receives an input ‘1’ and only the count C₂ is increased.

Accordingly, the X-ray detector 200 reduces a dynamic current according to a counting operation, that is, a digital operation, thereby realizing a reduction of noise and a minimization of power efficiency loss, and reduces coupling noise transferred to analog terminals, thereby preventing distortion of image signals. In addition, the X-ray detector 200 reduces overall system power consumption and realizes an improvement of signal to noise ratio (SNR), while further enhancing sensitivity.

The counts of the respective counters are transferred to the control unit 310 and are used for production of X-ray images of the object 30. The control unit 310 may produce a plurality of single energy images of the object 30.

Regarding a plurality of energy bands, as shown in FIG. 6A, when a lower limit energy E₂ₘᵢₙ of E_{band2} is an upper limit energy of E_{band1} and a lower limit energy E₃ min of E_{band3} is an upper limit energy of E_{band2}, X-ray data transferred from the X-ray detector 200, that is, the counts C₁, C₂ and C₃ of the first counter 224-1 to the third counter 224-3, may provide the basis for single energy images corresponding to the energy bands E_{band1}, E_{band2} and E_{band3}.

Alternatively, when the energy bands (first energy band, second energy band and third energy band) have different lower limit energies, E₁ₘᵢₙ, E₂ₘᵢₙ and E₃ₘᵢₙ, and an identical upper limit energy, a single energy image of the third energy band may be generated by summing the counts C₁, C₂ and C₃, and a single energy image of the second energy band may be generated by summing the counts C₁ and C₂.

That is, the control unit 310 processes X-ray data transferred from the X-ray detector 200 to produce a single energy image of the desired energy band, applies a suitable weight to at least one of a plurality of single energy images, and adds or excludes the resulting single energy image to generate a multiple energy image. There are a variety of other methods of generating multiple energy images and the exemplary embodiments are not limited to any particular method of generating multiple energy images.

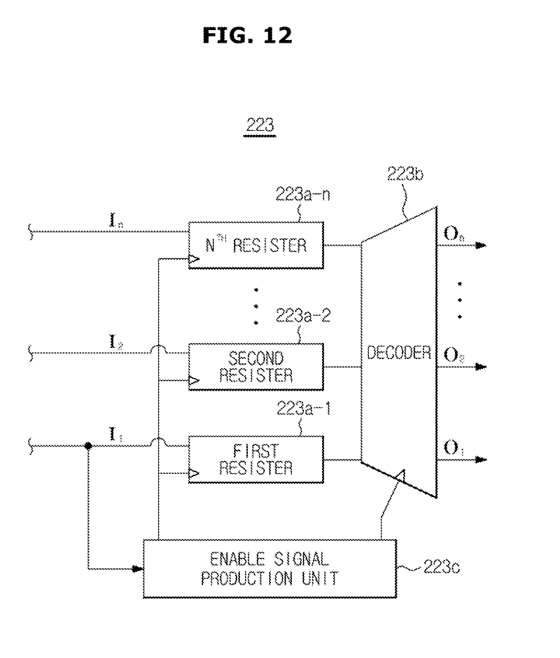

FIG. 12 illustrates an example of a structure of a circuit of the synchronous control circuit. According to an exemplary embodiment, photons detected by the X-ray detector 200 are separated according to three or more energy bands.

The synchronous control circuit 223 has a circuit structure implementing inputs and outputs in accordance with the truth table of FIG. 11A described above. For example, as shown in FIG. 12, the synchronous control circuit 223 includes a plurality of storage units 223a corresponding respectively to energy bands and a decoder 223b.

Each storage unit 223a may be implemented by a register and storage of data may be synchronized with a clock pulse. The register 223a may receive, as input, data on a rising edge of a clock pulse and store the same and maintains the original state until a next rising edge is input. In this case, the register 223a may be a flip-flop type register.

Alternatively, the register 223a may receive and store data while a ‘high’ clock pulse is input and the register 223a may maintain the original state while a ‘low’ clock pulse is input. In this case, the register 223a may be a latch type.

The decoder 223b is a combinational logic circuit which transforms m inputs into m to 2m (in which m is an integer of 1 or more) pieces of information and outputs the information. According to an exemplary embodiment, the decoder 223b has n inputs and n outputs, wherein n is an integer of 2 or more.

When the number of energy bands to be separated is n, the comparison unit 222 includes n comparators and pulse signals output from the respective comparators are input signals I₁ and I₂ to Iₙ of a first register 223a-1, and a second register 223a-2 to an n^{th} resister 223a-n, respectively.

The registers 223a-1 to 223a-n store input signals I₁ and I₂ to Iₙ and output the same according to a clock pulse and the decoder 223b performs logical operations on the input signals and generates outputs in accordance with the aforementioned truth table.

According to an exemplary embodiment, the synchronous control circuit 223 may further include an enable signal production unit 223c to generate an enable signal to be input to the register 223a and the decoder 223b. The enable signal production unit 223c may generate an enable signal synchronized with an input signal I.

According to an exemplary embodiment, the clock pulse input to the register 223a is an enable signal, and another enable signal which turns on and off an operation of the register according to a structure of the register 223a, independently of the clock pulse, may be further input. Also, a separate control signal, such as a set or reset signal, may be input.

The enable signal production unit 223c may generate an identical clock pulse and output the same to all the registers according to a structure of the register 223a and may generate a clock pulse suitable for the input signal I of each register 223a and input the same to the register 223a.

For example, in the case in which the registers 223a input data only on a rising edge of the clock pulse and store the same, different clock pulses are respectively generated and input to the registers 223a, and in the case in which the register 223a inputs and stores data during a clock pulse having a ‘high’ stage, an identical clock pulse is generated and input to all the registers 223a.

The decoder 223b generates an output only when a high enable signal is input. Alternatively, the decoder 223b may be designed to generate an output only when a low enable signal is input according to circuit configuration.

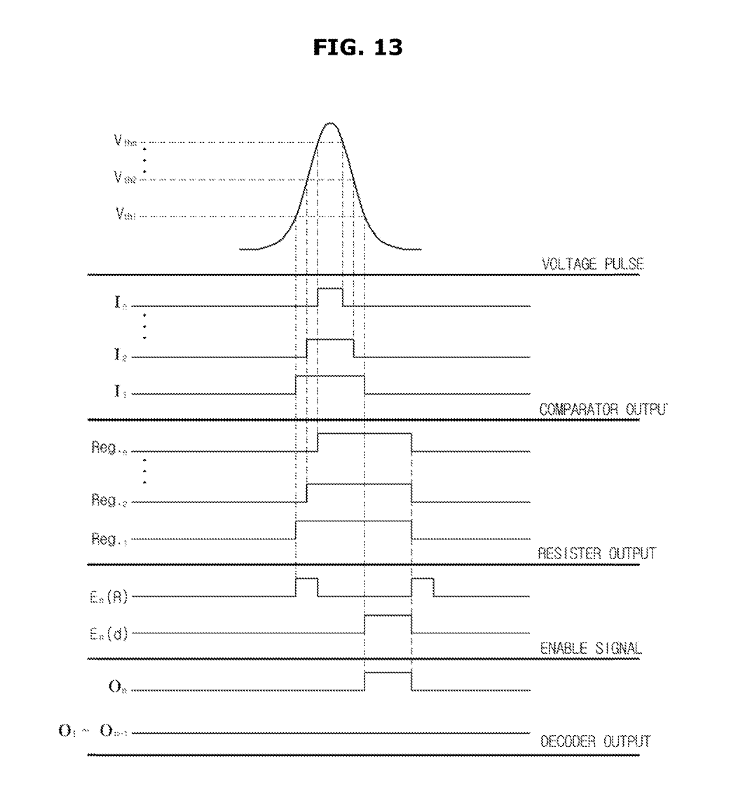

FIG. 13 is a timing chart illustrating outputs of the register and the decoder of the synchronous control circuit when a voltage pulse is input. According to an exemplary embodiment, photons detected by the X-ray detector 200 are separated according to n (n being an integer of 3 or more) energy bands. Hereinafter, a detailed operation of the synchronous control circuit 223 will be described with reference to FIG. 13.

As shown in FIG. 13, when a voltage pulse greater than an n^{th} threshold voltage Vₜₕₙ is input to the comparison unit 222, all of n comparators included in the comparison unit 222 output a ‘1’ state of pulses and the pulses become inputs I₁, and I₂ to Iₙ of the synchronous control circuit 223.

When the registers 223a store data during a high state of the enable signal, an enable signal Eₙ(R) shown in FIG. 13 may be input in common to the n registers 223a.

The enable signal production unit 223c synchronizes a pulse signal output from the first comparison unit 222-1, that is, the input signal I₁ corresponding to the first energy band which is the lowest energy band, and generates an enable signal of the register 223a and the decoder 232b. When the input signal I₁ is in a ‘1’ state, enabling of all the registers 223a may be possible.

While the enable signal Eₙ (R) of the register 223a maintains the high state, a signal, which is stored in the register and is then output therefrom, is also changed according to input signal. Accordingly, while the enable signal Eₙ (R) of the register 223a maintains the high state, as shown in FIG. 13, a change of the input signals I₁ and I₂ to Iₙ is reflected in output signals Reg.₁, and Reg.₂ to Reg.ₙ of the registers 223a.

The enable signal Eₙ (R) of the register shown in FIG. 13 is provided as an example and any signal may be used as the enable signal of the register so long as rising of the input signals I₁ and I₂ to Iₙ is reflected in the register 223a and falling of the input signals I₁ and I₂ to Iₙ is not reflected therein until the output of the decoder 223b is completed.

According to an exemplary embodiment, in the case in which the register 223a stores data on a rising edge or a falling edge of the enable signal, separate enable signals may be input respectively to the n registers 223a. In this case, as well, any signal may be used as the enable signal of the register so long as rising of the input signals I₁ and I₂ to Iₙ is reflected in the register 223a and falling of the input signals I₁ and I₂ to Iₙ is not reflected therein until the output of the decoder 223b is completed.

The decoder 223b reflects all of the results of the first comparator to the n^{th} comparator and transfers a pulse signal having the highest threshold voltage among inputs indicating ‘1’, that is, a pulse signal corresponding to the greatest energy band, to the corresponding counter and transfers the remaining pulse signals thereto as ‘0’.

In order words, ‘1’ is input to one of the counters corresponding to a highest one of the threshold voltages compared with the input indicating ‘1’, and ‘0’ is input to the remaining counters. Put another way, the counter corresponding to the comparator having the highest threshold voltage among comparators outputting an input signal indicating ‘1’ outputs ‘1’ and the remaining counters output ‘0’.

For this purpose, the enable signal production unit 223c generates a high state of an enable signal Eₙ(d) and inputs the same to the decoder 223b when the input signal I₁ is transformed from ‘1’ to ‘0’. The decoder 223b performs logical operations on output signals Reg.₁, and Reg.₂ to Reg.ₙ of the registers 223a as inputs. In the example of FIG. 13, each of Reg.₁ and Reg.₂ to Reg.ₙ maintain ‘1’ and the decoder 223b generates an output corresponding to the Reg.ₙ, an output corresponding to the n^{th} energy band or an output Oₙ corresponding to the n^{th} counter, as ‘1’, and generates the remaining outputs O₁ to Oₙ₋₁, as ‘0’, and inputs the outputs to the respective counters.

According to an exemplary embodiment, when the enable signal Eₙ (d) of the decoder 223b is changed to a low state and an operation of the decoder 223b is finished, the output of the register 223a may be reset. In the present exemplary embodiment, signals stored in the register 223a may be dropped to ‘0’ through ‘0’-state input signals I₁ and I₂ to Iₙ by inputting the high state of the enable signal.

Alternatively, when the register 223a has a separate reset terminal, data stored in the register 223a may be reset by inputting a low or high-state reset signal to the register 223a according to a design of the register 223a.

Alternatively, when a next voltage pulse is input, the previous state of data is reset and next data is stored, and the register 223a thus does not need to be separately reset.

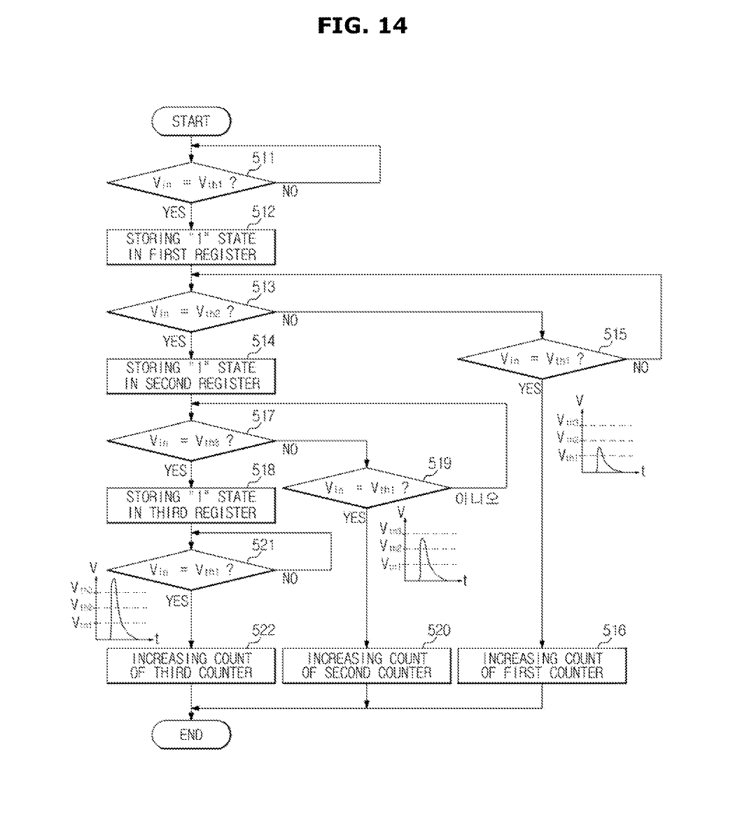

FIG. 14 is a flowchart illustrating an example of an operation of the synchronous control circuit over the course of time when a voltage pulse is input by a single photon according to an exemplary embodiment. According to an exemplary embodiment, photons incident upon the X-ray detector 200 are separated into three energy bands. It is understood that more or less than three energy bands may be used according to other exemplary embodiments.

As described above, a voltage pulse generated by the photon is an input voltage Vᵢₙ which passes through the preamplifier 221 and is then input to the comparators 222-1, 222-2 and 222-3. When the input voltage reaches the first threshold voltage Vₜₕ₁ (YES of operation 511), a ‘1’ state is stored in the first register 223a-1 at operation 512.

In addition, when the input voltage Vᵢₙ reaches the second threshold voltage Vₜₕ₂, (YES of operation 513), a ‘1’ state is stored in the second register 223a-2 at operation 514. On the other hand, when the input voltage Vᵢₙ does not reach the second threshold voltage Vₜₕ₂ (NO of operation 513) and reaches the first threshold voltage Vₜₕ₁ again (YES of operation 515), the input voltage Vᵢₙ reaches a peak value and then falls. Accordingly, the first counter 224-1 is incremented at operation 516).

In the case in which the ‘1’ state is stored in the second register 223a-2, when the input voltage Vᵢₙ reaches the third threshold voltage Vₜₕ₃ (YES of operation 517), a ‘1’ state is stored in the third register 223a-3 at operation 518. On the other hand, when the input voltage Vᵢₙ does not reach the third threshold voltage Vₜₕ₃ (NO of operation 517) and reaches the first threshold voltage Vₜₕ₁ (YES of operation 519), the input voltage Vᵢₙ reaches a peak value and then falls. Accordingly, the second counter 224-2 is incremented at operation 520.

In the case in which a ‘1’ state is stored in the third register 223a-3, the input voltage Vᵢₙ reaches the first threshold voltage Vₜₕ₁ again (YES of operation 521), the input voltage Vᵢₙ reaches a peak value and then falls. Accordingly, the third counter 224-3 is incremented at operation 522).

Hereinafter, a method of controlling the X-ray imaging device according to an exemplary embodiment will be described.

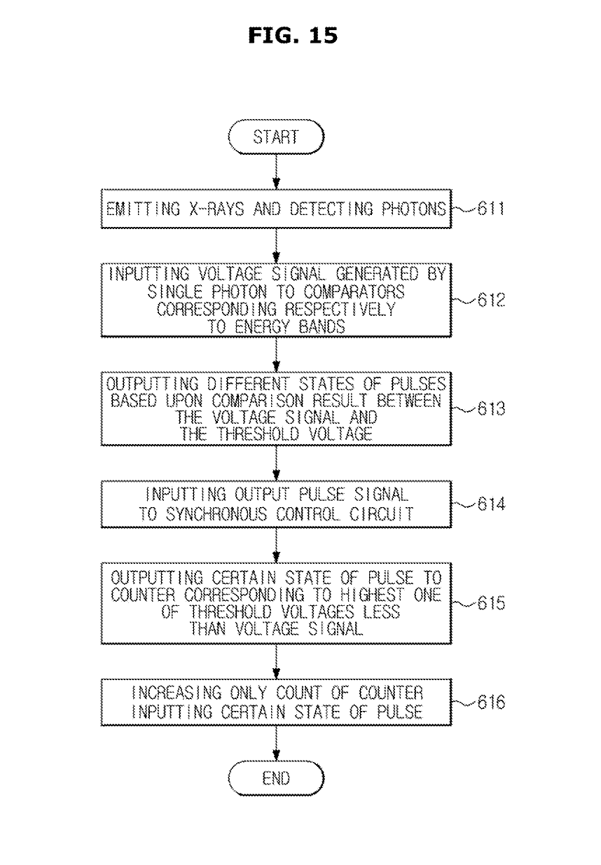

FIG. 15 is a flowchart illustrating a method of controlling the X-ray imaging device according to an exemplary embodiment. According to an exemplary embodiment, the X-ray imaging device 10 described above may be used, although it is understood that other X-ray imaging devices may also be used in accordance with the method of FIG. 15.

First, X-rays of a plurality of predetermined energy bands are emitted and photons of the X-rays are detected at operation 611. The energy bands may be set according to type or characteristics of the object and are different from one another. When at least one of an upper limit and a lower limit of the energy bands are different, the energy bands are considered to be different.

A voltage signal generated by a single photon is input to the comparators corresponding respectively to the energy bands at operation 612. A voltage signal generated by a single photon corresponds to energy of a single photon and threshold voltages corresponding respectively to the energy bands are input to the comparators corresponding respectively to the energy bands.

Based upon results of comparison of the voltage signal with the threshold voltage by each of the comparators, pulses of different states are output at operation 613. For example, the pulse may be in a high or low state. In this case, when the voltage signal is higher than the threshold voltage, a high pulse is output and when the voltage signal is lower than the threshold voltage, a low pulse is output. Alternatively, a reverse output behavior may be possible according to circuit configuration.

The output pulse signal is input to the synchronous control circuit at operation 614. The synchronous control circuit 223 may be provided between the comparison unit 222 and the counter unit 224, as described with respect to FIG. 10, above. An example of the synchronous control circuit 223 is shown in FIG. 12, but the exemplary embodiments are not limited thereto.

The synchronous control circuit 223 outputs a pulse of a certain state to one of the counters corresponding to a highest one of threshold voltages less than the voltage signal at operation 615. In addition, the synchronous control circuit 223 outputs a pulse in a state opposite to the certain state to the counters corresponding to the remaining threshold voltages. According to an exemplary embodiment, the term voltage signal may refer to a peak value of the voltage signal.

Specifically, the synchronous control circuit 223 performs logical operations on the input pulse signal, outputs a pulse having a certain state to one of the counters corresponding to a highest one of threshold voltages of the comparator outputting a pulse indicating that the voltage signal is higher than the threshold voltage and outputs a pulse having a state opposite to the certain state to the remaining counters. The pulse having the certain state is a pulse which may be designed to be counted by the counter and may be a high- or low-state pulse according to circuit structure of the counter.

In addition, at operation 616, a count of only the counter inputting the pulse having the certain state is increased. That is, only one of the counters corresponding to a highest one of the threshold voltages of comparators outputting a pulse indicating that the voltage signal is higher than the threshold voltage performs a counting operation and increases in count.

For example, when the X-ray imaging device is designed such that the comparator outputs a pulse of a high state when the voltage signal is higher than the threshold voltage and the counter counts the pulse of the high state, the synchronous control circuit 233 outputs a pulse of the high state to one of the counters corresponding to a highest one of the threshold voltages of the comparators outputting the pulse of the high state and outputs a pulse of a low state to the remaining counters.

The aforementioned method may be performed on all pixels of the X-ray detector 200 and all incident photons and counts corresponding respectively to threshold voltages of the respective pixels are transferred to the control unit 310 as X-ray data of energy bands corresponding respectively to the threshold voltages. The transferred X-ray data may then be used for production of single energy images corresponding respectively to the energy bands and of a multiple energy image using the single energy images.

As apparent from the foregoing description, in accordance with an X-ray detector, an X-ray imaging device including the X-ray detector and a method of controlling the X-ray imaging device according to exemplary embodiments, it may be possible to reduce digital operations of the X-ray detector and thereby reduce noise generated by a dynamic current, while further minimizing a loss of power efficiency.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An X-ray detector comprising:
a light receiver configured to generate charges of a quantity corresponding to energy of a photon when the photon is incident on the light receiver;
a comparison device including a plurality of comparators, each of the comparators being configured to compare a voltage signal corresponding to the quantity of the generated charges with a respective threshold voltage among a plurality of threshold voltages corresponding respectively to a plurality of different energy bands and output a result of the comparison as a pulse signal;
a counter device including a plurality of counters provided respectively according to the threshold voltages, each of the counters being configured to count a pulse of a certain state; and
a synchronous control circuit provided between the comparison device and the counter device, the synchronous control circuit being configured to receive as input the pulse signals output from each of the comparators and to output the pulse of the certain state to one of the counters corresponding to a highest threshold voltage of the threshold voltages which is less than a peak value of the voltage signal and to output a pulse of a state opposite to the certain state to the remaining counters.

2. The X-ray detector according to claim 1, wherein each of the comparators of the comparison device is configured to output a pulse of a high state or a low state, based on the result of the comparison.

3. The X-ray detector according to claim 2, wherein the certain state of the pulse counted by each counter of the counter device is a high state or a low state.

4. The X-ray detector according to claim 3, wherein each of the comparators of the comparison device is configured to output the pulse of the high state when the voltage signal is higher than the threshold voltage and output the pulse of the low state when the voltage signal is lower than the threshold voltage.

5. The X-ray detector according to claim 4, wherein the synchronous control circuit is configured to output the pulse of the high state to one of the counters corresponding to the highest threshold voltage of the threshold voltages of the comparators outputting the pulse of the high state, and output the pulse of the low state to the counters corresponding to the remaining threshold voltages.

6. The X-ray detector according to claim 3, wherein the synchronous control circuit comprises:
a plurality of storages configured to store the pulse signals output from the comparators; and
a logic circuit configured to perform a logical operation on the pulse signals output from the storages and output the pulse of the certain state to one of the counters corresponding to the highest one of the threshold voltages of the comparators outputting a pulse indicating that the voltage signal is higher than the respective threshold voltage.

7. The X-ray detector according to claim 6, wherein the storages comprise registers which are provided respectively according to the threshold voltages.

8. The X-ray detector according to claim 7, wherein the logic circuit comprises a decoder having inputs of a same number as a number of the threshold voltages and outputs of the same number as the number of the threshold voltages.

9. The X-ray detector according to claim 1, wherein the comparison device, the counter device and the synchronous control circuit are provided on a pixel basis.

10. An X-ray imaging device comprising:
an X-ray source configured to emit X-rays of a plurality of predetermined energy bands to an object; and
an X-ray detector configured to detect X-rays transmitted through the object among the emitted X-rays,
wherein the X-ray detector comprises:
a light receiver configured to generate charges of a quantity corresponding to energy of a photon when the photon is incident on the light receiver;
a comparison device including a plurality of comparators, each of the comparators being configured to compare a voltage signal corresponding to the quantity of the generated charges with a respective threshold voltage among a plurality of threshold voltages corresponding respectively to a plurality of different energy bands and output a result of the comparison as a pulse signal;
a counter device including a plurality of counters provided respectively according to the threshold voltages, each of the counters being configured to count a pulse of a certain state; and
a synchronous control circuit provided between the comparison device and the counter device, the synchronous control circuit being configured to receive as input the pulse signals output from each of the comparators and to output the pulse of the certain state to one of the counters corresponding to a highest threshold voltage of the threshold voltages which is less than a peak value of the voltage signal and to output a pulse of a state opposite to the certain state to the remaining counters.

11. The X-ray imaging device according to claim 10, wherein each of the comparators of the comparison device is configured to output a pulse of a high state or a low state based on the result of the comparison, and wherein the certain state of the pulse counted by each of the counters of the counter device is a high state or a low state.

12. The X-ray imaging device according to claim 11, wherein the synchronous control circuit comprises:
a plurality of storages configured to store the pulse signals output from the comparators; and
a logic circuit configured to perform a logical operation on the pulse signals output from the storages and output the pulse of the certain state to one of the counters corresponding to the highest threshold voltage of the threshold voltages of the comparators outputting a pulse indicating that the voltage signal is higher than the threshold voltage.

13. The X-ray imaging device according to claim 12, wherein the storages comprise registers which are provided respectively according to the threshold voltages.

14. The X-ray imaging device according to claim 13, wherein the logic circuit comprise a decoder having inputs of a same number as a number of the threshold voltages and outputs of the same number as the number of the threshold voltages.

15. The X-ray imaging device according to claim 10, further comprising:
a controller configured to generate single energy images corresponding to energy bands corresponding to the threshold voltages based upon the counts of the counters and generate a multiple energy image of the object using the single energy images.

16. The X-ray imaging device according to claim 15, wherein the controller is configured to generate the multiple energy image by applying a weight to at least one of the single energy images to generate at least one weighted image and combining the resulting at least one weighted image and the single energy images.

17. A method of controlling an X-ray imaging device configured to count photons incident upon an X-ray detector, the method comprising:
emitting X-rays of a plurality of predetermined energy bands to an object;
inputting a voltage signal generated based on a photon of one of the X-rays transmitted through the object to a plurality of comparators having respective threshold voltages corresponding respectively to the energy bands;
comparing, by a comparator, the voltage signal with the threshold voltages and outputting a result of the comparing as a pulse signal;
outputting a pulse of a certain state to a counter corresponding to a highest threshold voltage of the threshold voltages which is less than a peak value of the voltage signal, and outputting a pulse having a state opposite to the certain state to other counters corresponding to the remaining threshold voltages, based upon the output pulse signal; and
counting the pulse of the certain state by the counter corresponding to the highest threshold voltage.

18. The method according to claim 17, wherein the outputting the pulse of the certain state and the outputting the pulse having the state opposite to the certain state comprises:
performing a logical operation on the output pulse signal and outputting the pulse of the certain state to one of the counters corresponding to the highest threshold voltage of the threshold voltages of the comparators outputting the pulse indicating that the voltage signal is higher than the respective threshold voltage.

19. The method according to claim 18, wherein the outputting the comparison result as the pulse signal comprises:
outputting a pulse of a high state or a low state, based on the comparison result, wherein the pulse of the certain state is a pulse of a high state or a low state.

20. The method according to claim 19, wherein the outputting the pulse of the certain state to one of the counters corresponding to the highest threshold voltage of the threshold voltages of the comparators outputting the pulse indicating that the voltage signal is higher than the respective threshold voltage comprises:
outputting the pulse of the high state to one of the counters corresponding to the highest threshold voltage of the threshold voltages of the comparators outputting the pulse of the high state.

21. An apparatus to be used with an X-ray detector, the apparatus comprising:
a plurality of comparators which are each configured to make a comparison between a voltage corresponding to a received photon and a unique threshold voltage respectively corresponding to the comparator;
a synchronous control circuit configured to output a signal having a first state corresponding to a first comparator among the plurality of comparators, the first comparator having a highest threshold voltage which is less than the voltage, and to output a signal having a second state corresponding to the remaining comparators, according to the respective comparisons; and
a plurality of counters corresponding to the plurality of comparators and configured to count only the pulse signals having the first state.
